(19) United States
(12) Patent Application Publication
(10) Pub. No.: US 2026/0012991 A1
(43) Pub. Date: Jan. 8, 2026

(54) Query-Response Framework for Access Point Multi-Link Device Discovery

(71) Applicant: Apple Inc., Cupertino, CA (US)

(72) Inventors: Yong Ho Seok, Cupertino, CA (US); Pooya Monajemi, Sunnyvale, CA (US); Anuj Batra, Redwood City, CA (US); Neelakantan Nurani Krishnan, San Diego, CA (US); Jarkko L. Kneckt, Los Gatos, CA (US); Yong Liu, Campbell, CA (US); Su Khiong Yong, Palo Alto, CA (US)

(21) Appl. No.: 19/238,116

(22) Filed: Jun. 13, 2025

Related U.S. Application Data
(60) Provisional application No. 63/667,599, filed on Jul. 3, 2024.

(51) Int. Cl. H04W 76/15; H04W 48/14; H04W 84/12

(52) U.S. Cl. CPC H04W 76/15; H04W 48/14; H04W 84/12

(57) ABSTRACT

This disclosure relates to methods for performing a query and response exchange for access point multi-link device discovery in a wireless local area network. A query frame can be transmitted from a non-access point wireless device to an access point wireless device to request neighbor access point information for non-collocated neighbor access point multi-link devices. A response frame can be received by the non-access point wireless device from the access point wireless device. The response frame can provide the requested neighbor access point information for non-collocated neighbor access point multi-link devices.

### PRIORITY INFORMATION

This application claims priority to U.S. provisional patent application Ser. No. 63/667,599, entitled “Query-Response Framework for Access Point Multi-Link Device Discovery,” filed Jul. 3, 2024, which is hereby incorporated by reference in its entirety as though fully and completely set forth herein.

### TECHNICAL FIELD

The present application relates to wireless communication, including techniques and devices for performing query-response based discovery for non-collocated access point multi-link devices in a wireless communication system.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards.

Access point discovery can be an important part of wireless device operation, for example for initial access point selection and for roaming operation. However, scanning for candidate access points can be time and power consuming, and providing extensive discovery information in broadcast beacon transmissions can have a large overhead cost. Accordingly, improvements in the field are desired.

### SUMMARY

Embodiments are presented herein of, inter alia, systems, apparatuses, and methods for devices to perform query-response based discovery for non-collocated access point multi-link devices in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a non-access point wireless device can provide a query frame to an access point wireless device to request neighbor access point information, which can include neighbor access point information for non-collocated access point multi-link devices. The query frame can specify certain query parameters and/or filtering criteria to focus the query.

The access point wireless device can obtain the requested neighbor access point information, for example by performing message exchanges with the neighbor access points for which it is gathering neighbor access point information to request and receive the neighbor access point information, and can provide the requested neighbor access point information back to the non-access point wireless device in a response frame.

The non-access point wireless device can potentially use the neighbor access point information to verify the results of its scanning operations, to facilitate access point selection, to maintain a candidate roaming access point list, to perform access point discovery for roaming, and/or for any of a variety of other possible purposes, according to various embodiments.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for query-response based discovery for non-collocated access point multi-link devices in a wireless communication system, according to some embodiments;

FIG. 6 illustrates example aspects of possible pre-roaming workflow operation by a wireless device, according to some embodiments;

FIG. 7 illustrates example aspects of a possible multi-link multi-device system with multiple non-collocated access point multi-link devices, according to some embodiments;

FIGS. 8-9 illustrate aspects of example systems in which discovery for non-collocated access point multi-link devices in the same access point multi-link multi-device can performed using a query-response framework, according to some embodiments;

FIGS. 10-11 illustrate aspects of a possible neighbor access point information query frame that could be used for non-collocated access point multi-link device discovery, according to some embodiments;

FIGS. 12-14 illustrate aspects of a possible neighbor access point information response frame that could be used for non-collocated access point multi-link device discovery, according to some embodiments;

FIG. 15 illustrates example aspects of a system in which discovery for non-collocated access point multi-link devices in a different access point multi-link multi-device can performed using a query-response framework, according to some embodiments;

FIG. 16 illustrates example aspects of a possible format modification to a neighbor AP information response frame that can be used for providing access point multi-link device information for a non-collocated access point multi-link device in a different access point multi-link multi-device, according to some embodiments;

FIG. 17 illustrates example aspects of a possible scanning results verification use case for performing query/response-based access point multi-link device discovery, according to some embodiments;

FIG. 18 illustrates example aspects of a roaming discovery enhancement use case for performing query/response-based access point multi-link device discovery, according to some embodiments;

FIG. 19 is a table illustrating an example set of parameters that could be used to solicit access point information in a query/response-based approach to non-collocated access point multi-link device discovery, according to some embodiments;

FIG. 20 is a table further illustrating how query parameters could be used in a query/response-based approach to non-collocated access point multi-link device discovery, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

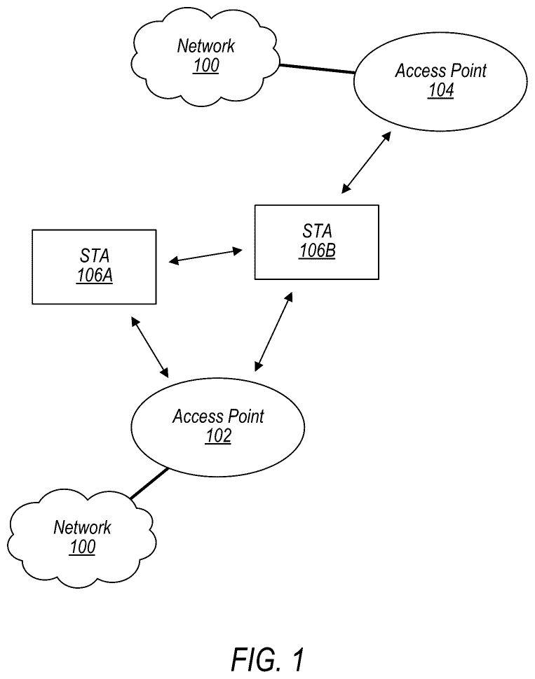

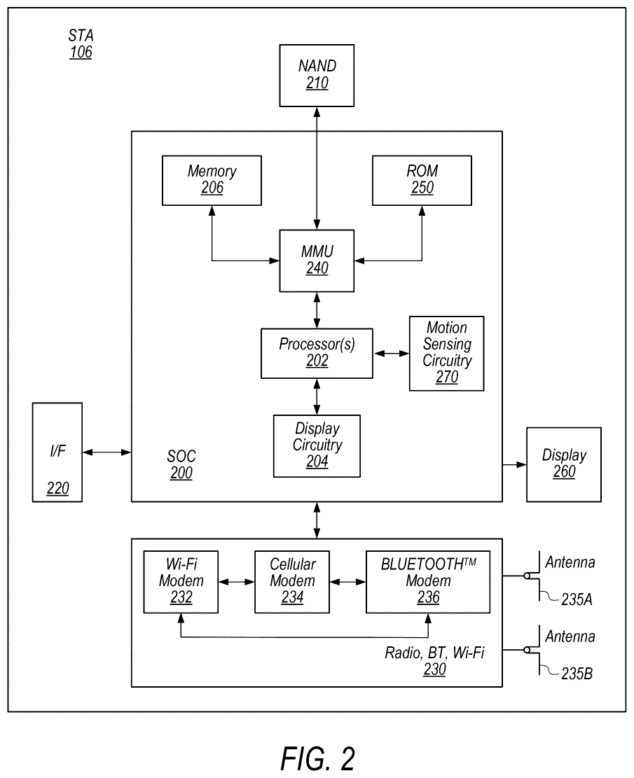

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform query-response based discovery techniques for non-collocated access point multi-link devices in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for performing query-response based discovery for non-collocated access point multi-link devices described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

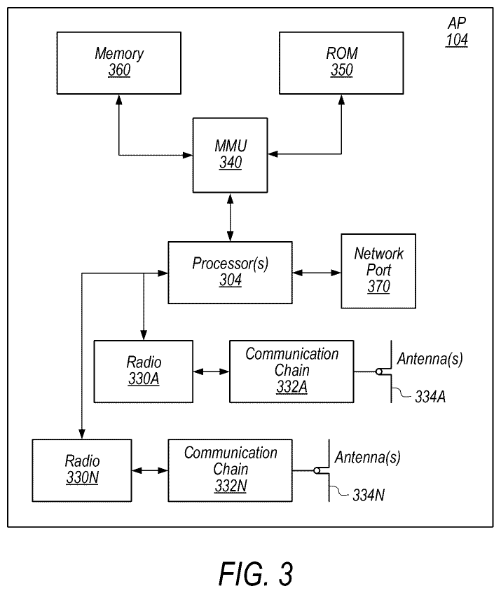

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as performing query-response based discovery for non-collocated access point multi-link devices, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

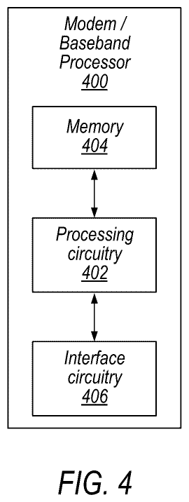

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as performing query-response based discovery for non-collocated access point multi-link devices, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

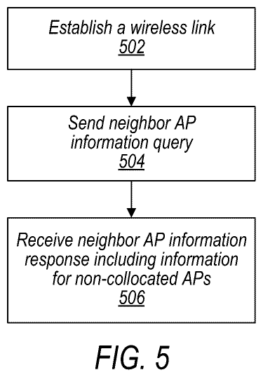

### FIG. 5—Non-Collocated Access Point Multi-Link Device Discovery

FIG. 5 is a flowchart diagram illustrating a method for supporting performing query-response based discovery for non-collocated access point multi-link devices in a wireless communication system, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

An access point (AP) wireless device may provide one or more basic service sets (BSSs). In some embodiments, the AP wireless device may be an AP multi-link device (MLD), which may be capable of providing a BSS on each of multiple links, such as on a 2.4 GHz link, a 5 GHz link, and/or a 6 GHz link. The AP wireless device may operate in a standalone manner or may be affiliated with one or more other devices, e.g., as part of a larger network. For example, the AP wireless device could be a member of a multi-access point (MAP) system, which could include multiple AP wireless devices, in some embodiments.

The AP wireless device may be capable of establishing a wireless association with one or more non-AP (or “STA”) wireless devices, and may accordingly establish a wireless link with a non-AP wireless device (502). One or more of the non-AP STA devices may also be MLDs. Such wireless associations may be established using Wi-Fi, wireless communication techniques that are based at least in part on Wi-Fi, and/or any of various other wireless communication technologies, according to various embodiments. For example, an access point (AP) wireless device may provide (e.g., broadcast) beacon transmissions including information for associating with the AP wireless device, and one or more other wireless devices (e.g., non-AP wireless devices) may request to associate with the AP wireless device using the information provided in the beacon transmissions, as one possibility. Use of (e.g., unicast) probe requests and probe responses may also be possible, in some instances, for a non-AP wireless device to obtain AP parameters and/or other system information for the AP wireless device. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

For example, at least according to some embodiments, performing a downlink data transmission from the AP wireless device to a non-AP wireless device in such a wireless local area network may include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs). Note that other types of transmissions (e.g., including triggered uplink frames, enhanced distributed channel access (EDCA) uplink frames, transmission opportunity (TXOP) sharing for peer-to-peer (P2P) communications, etc.) may also be possible in such a wireless local area network.

One or more non-collocated AP MLDs can share a common management entity for roaming, termed multi-link multi-device (MLMD). In other words, each non-collocated AP MLD can be affiliated with a single AP MLMD, at least in some instances. Roaming within the same MLMD can be seamlessly achieved, in some embodiments. Quick identification of candidate non-collocated AP MLDs can help a STA MLD to efficiently transition to the best available AP MLD when the current connection degrades. By leveraging the current AP MLD to discover other non-collocated AP MLDs, the system can pre-emptively prepare for roaming, potentially reducing latency and improving the overall user experience.

The non-AP wireless device may generate and transmit, to its current serving AP wireless device, a query frame that requests neighbor AP information for non-collocated neighbor AP MLDs (502). The query frame can potentially request neighbor AP information for non-collocated neighbor AP MLDs that are associated with the same AP (MLMD) system as the current serving AP wireless device and/or non-collocated neighbor AP MLDs that are associated with one or more different AP MLMD systems than the current serving AP wireless device, according to various embodiments. The query frame can also potentially request neighbor AP information for collocated neighbor APs and/or AP MLDs, in some instances.

The query may be included in a neighbor AP information query frame, a basic service set (BSS) transition management (BTM) query frame, or any of various other possible types of frames, according to various embodiments. In some embodiments, the query frame may include an indication of one or more query parameter and/or filtering criteria to request one or more specific types of neighbor AP information. For example, the query frame could include one or more non-collocated AP MLD media access control (MAC) addresses (e.g., a list of such MAC addresses) to indicate to the AP wireless device to provide neighbor AP information for AP MLDs associated with those MAC addresses. As another example, a filtering criterion could be indicated to require that the reported neighbor AP information be for neighbor APs (e.g., including non-collocated neighbor AP MLDs) that are reachable by (e.g., within wireless communication range of) the current serving AP wireless device. In some instances, the query could indicate one or more service set identifiers (SSIDs) or robust security networks (RSNs), e.g., for AP MLDs associated with different AP MLMDs, to request neighbor AP information associated with those SSIDs and/or RSNs. Use of such filtering criteria and/or query parameters can potentially reduce the computational and/or signaling cost to perform the query/response exchange in scenarios in which the non-AP wireless device can determine that it only needs certain specific types of neighbor AP information and/or only needs neighbor AP information for certain types of neighbor APs, at least according to some embodiments.

Numerous other query parameters can potentially additionally or alternatively be used, according to various embodiments. For example, the indicated query parameters could include any or all of one or more SSID parameters (e.g., an SSID list, a short SSID list including a 4 octet hash of SSID(s), etc.), one or more band or channel parameters (e.g., a band list, a channel list, an operating class list, a BSS color bitmap list, etc.), one or more address parameters (e.g., BSSID list to indicate APs for which information is requested, known BSSID list to indicate APs for which information is not requested, MLD address list, etc.) one or more short ID parameters (e.g., MLMD ID bitmap, MLD ID bitmap, link ID bitmap, etc.), one or more information content parameters (e.g., indicating one or more types of information content requested for neighbor APs, such as BSS load, BSS performance parameters, etc.), and/or any of various other possible query parameters.

The AP wireless device can select which neighbor AP information (e.g., including which types of neighbor AP information and from which neighbor APs) to collect and include in a response frame based at least in part on the indicated query parameter(s). For example, the AP wireless device could determine to collect and include only the neighbor AP information that meets the requested query parameters/filtering criteria. If multiple query parameters/filtering criteria are indicated in the query frame, the AP wireless device could determine to collect and include the neighbor AP information that meets all such requested query parameters/filtering criteria. At least in some embodiments, if no query parameters/filtering criteria are indicated, the AP wireless device could determine to collect and include all available neighbor AP information.

The AP wireless device can perform one or more message exchanges with one or more neighbor AP devices (e.g., including any selected non-collocated neighbor AP MLDs) to obtain the selected neighbor AP information. The message exchanges can be performed via over-the-air (OTA) or over-the-distribution system (OTDS) communication, for example using wireless or wired backhaul or other communication interface, according to various embodiments. For example, the AP wireless device can request and/or scan for the determined types of neighbor AP information with each of the determined neighbor AP wireless devices, and each of those neighbor APs can respond with some or all of the requested neighbor AP information.

The AP wireless device can transmit a response frame to the non-AP wireless device in response to the query frame, which can provide the requested neighbor AP information for non-collocated neighbor AP MLDs (506). The response may be included in a neighbor AP information response frame, a BTM request frame, or any of various other possible types of frames, e.g., corresponding to the type of frame in which the query was received, according to various embodiments. The neighbor AP information can potentially include neighbor AP information for non-collocated neighbor AP MLDs that are associated with the same AP MLMD system as the current serving AP wireless device and/or non-collocated neighbor AP MLDs that are associated with one or more different AP MLMD systems than the current serving AP wireless device, according to various embodiments. The response frame can also potentially include neighbor AP information for collocated neighbor APs and/or AP MLDs, in some instances.

The neighbor AP information provided in the response frame may generally correspond to the requested query parameters and/or filtering criteria indicated in the query frame, if any. Thus, as previously described herein, the AP wireless device could include only the neighbor AP information that meets the requested query parameters/filtering criteria, potentially including providing the neighbor AP information that meets all such requested query parameters/filtering criteria if multiple query parameters/filtering criteria are indicated in the query frame. As also previously described herein, it can be the case that if no query parameters/filtering criteria are indicated, the AP wireless device collects all available neighbor AP information. Thus, in this case, all available neighbor AP information can be provided in the response frame.

As one possible example, in a scenario in which the query frame indicates one or more non-collocated AP MLD MAC addresses, the response frame could include neighbor AP information only for AP MLDs associated with those MAC addresses. Similarly, in a scenario in which the query frame indicates a requirement that reported non-collocated neighbor AP MLDs are within wireless communication range of the AP wireless device as a filtering criterion, the response frame could include neighbor AP information only for APs that are within wireless communication range of the AP wireless device. Other examples are also possible.

The available neighbor AP information could include any of a variety of types of information, e.g., subject to the requested query parameters/filtering criteria. In some embodiments, a multi-link (ML) element can be included in the response frame for each of one or more neighbor AP MLDs for which neighbor AP information is being provided. As some examples, the neighbor AP information (e.g., in each ML element) could include any or all of operating class, channel number, capability and operating parameter information, BSSID, beacon interval, timing synchronization function (TSF) offset, BSS parameter change count, BSS load, AP transmit power, SSID, or RSN. Some of the types of information provided may depend on the type of AP corresponding to the information; for example, in some instances, a ML element for an AP MLD in a different AP MLMD than the current serving AP wireless device could include an indication of SSID and RSN for the AP MLD, while a ML element for an AP MLD in the same AP MLMD as the current serving AP wireless device might not include such information.

Thus, according to the method of FIG. 5, it can be possible for wireless devices to perform a query/response exchange for non-collocated AP MLD discovery, at least according to some embodiments. Such exchanges can potentially be useful for a variety of use cases, including verifying scanning results obtained by a non-access point wireless device, performing AP discovery and auto-join, performing AP discovery for roaming, checking roaming candidate AP load and parameters, and/or in any of a variety of other possible scenarios, according to various embodiments.

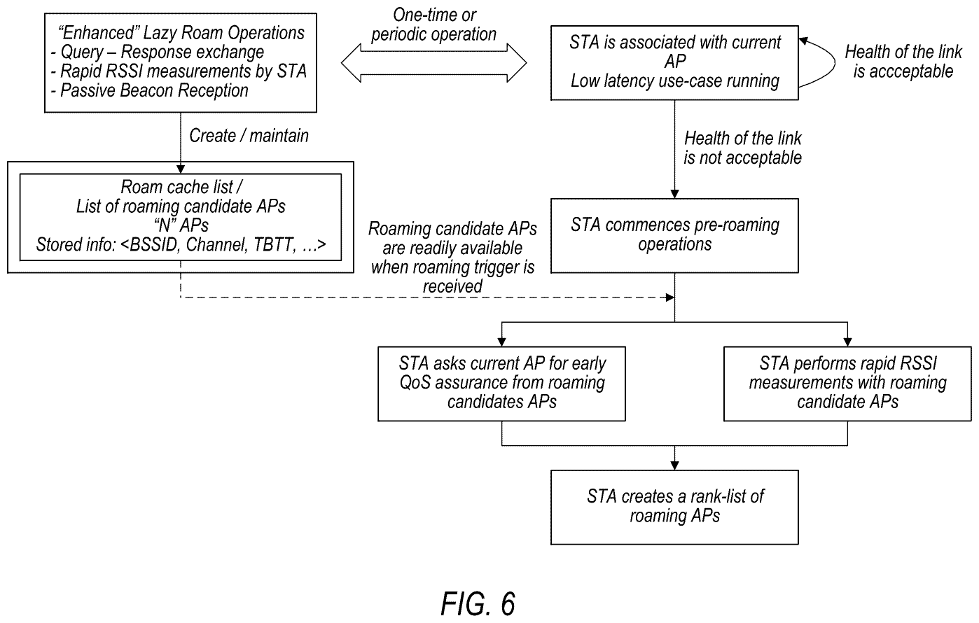

### FIGS. 6-20 and Additional Information

FIGS. 6-20 illustrate further aspects that might be used in conjunction with the method of FIG. 5. It should be noted, however, that the exemplary details illustrated in, and described with respect to, FIGS. 6-20 are not intended to be limiting to the disclosure as a whole: numerous variations and alternatives to the details provided herein below are possible and should be considered within the scope of the disclosure.

In IEEE 802.11be, it can be the case that a non-AP MLD can discover the APs affiliated with the AP MLD by receiving the reduced neighbor report (RNR) in the beacon frame (e.g., passive discovery), and/or by exchanging a multi-link (ML) probe request and response (e.g., active discovery). Further techniques are described herein for a non-AP MLD to perform discovery of non-collocated AP MLDs affiliated with the same multi-link multi-device (MLMD) system.

FIG. 6 illustrates example aspects of possible pre-roaming workflow operation by a wireless device, according to some embodiments. As shown, while a STA is associated with a current AP (possibly with low latency use-case running), the STA may, as a one-time or periodic operation, perform “enhanced lazy roam operations,” which can include one or more of a query response exchange, rapid RSSI measurements by the STA, and/or passive beacon reception. Such operations can be used to create and maintain a roam cache list, e.g., to track a list of roaming candidate APs. For example, up to “N” APs can have stored info such as BSSID, Channel, TBTT, and/or any of various other possible parameters. When health of the link with the current AP is deemed non acceptable, the STA can commence pre-roaming operations. The roaming candidate APs may be readily available from the roam cache list when the roaming trigger is received. Accordingly, the STA may be able to quickly ask the current AP for early QoS assurance for the roaming candidate APs and/or perform rapid RSSI measurements with roaming candidate APs and to create a rank-list of roaming candidate APs, which can be used to select an AP to which to roam.

In some embodiments, (e.g., in systems using 802.11be multi-link operation (MLO) architecture, in some instances), the information for the APs affiliated with an AP MLD can be split into two elements. In the beacon frame, the reduced neighbor report (RNR) element can provide the operating class, channel number, SSID, etc. In the (re-)association response and ML probe response, the basic multi-link element can provide the operating parameters, capabilities, etc.

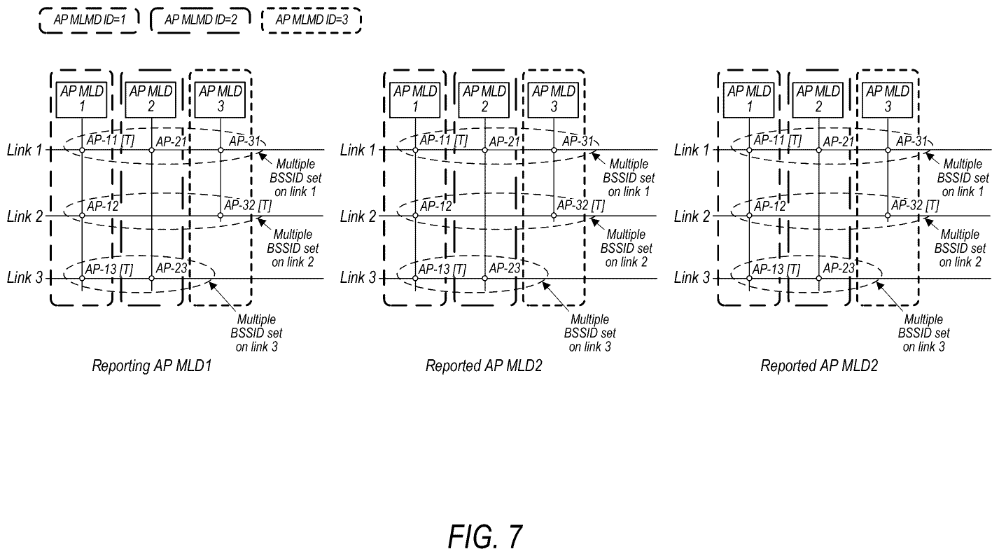

In some embodiments (e.g., in systems using 802.11bn, in some instances), the RNR element can be extended to carry the information of non-collocated AP MLDs affiliated with the same AP MLMD system. In such a case, another ID (e.g., MLMD ID) may be defined to identify the non-collocated AP MLD affiliated with the same MLMD system. However, the beacon overhead can potentially be significantly increased as the reported non-collocated AP MLD count increases. FIG. 7 illustrates example aspects of a possible system with multiple MLMDs including multiple non-collocated AP MLDs.

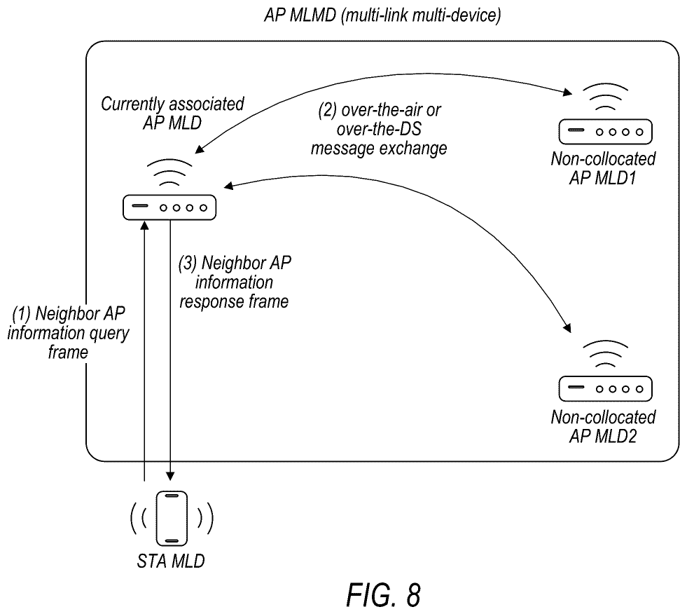

A query-response framework can be used as an alternative or additional technique for performing AP MLMD discovery. FIG. 8 illustrates aspects of an example system in which such discovery for non-collocated AP MLDs in the same AP MLMD can performed, according to some embodiments. As shown, a STA MLD can receive information pertinent to non-collocated MLD(s) affiliated with the same MLMD through the current associated MLD. The STA MLD can send a neighbor AP information query frame to the currently associated AP MLD; the current AP MLD can perform over the air or over the distribution system (DS) message exchange to obtain information for non-collocated AP MLDs in the system and send information about the non-collocated AP MLD(s) to the STA MLD using a neighbor AP information response frame. These frames can be protected management frames, at least in some instances. The neighbor AP information response frame can contain one or more basic multi-link element for each non-collocated AP MLD, which can for example indicate any or all of operating class and channel number, capabilities and operating parameters, BSSID, beacon interval, TSF offset, BSS parameter change count, BSS load, AP transmit power, etc. In some embodiments, the STA MLD may be able to specify certain request parameters in the neighbor AP information query frame, such as a list of non-collocated AP MLD MAC addresses of interest (e.g., if known), neighbor AP filtering information (e.g., indicating if only reachable AP reporting is requested, and/or if any other filtering parameters are requested), and/or any of various other possible request parameters.

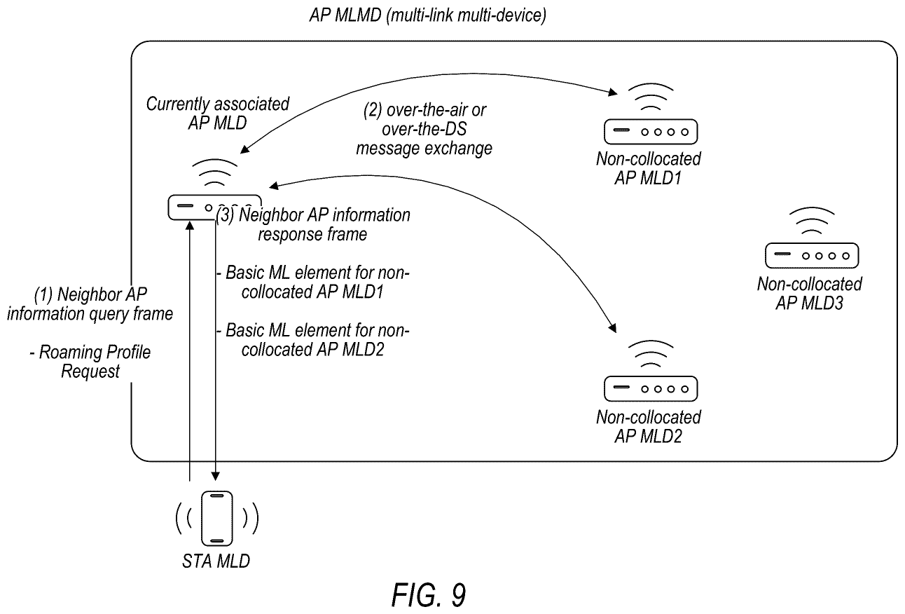

FIG. 9 illustrates aspects of another example system in which such discovery for non-collocated AP MLDs in the same AP MLMD can performed, according to some embodiments. As shown, when the STA MLD sends the neighbor AP information query frame to the currently associated AP MLD in the illustrated example, it requests the roaming profile, which can include the BSS load and AP transmit power of the non-collocated AP MLD(s). In the neighbor AP information query frame, the neighbor AP filtering information indicates to only report non-collocated AP MLDs that are reachable by the current AP MLD. Accordingly, the current AP MLD then sends information about non-collocated AP MLD1 and non-collocated AP MLD2 to the STA MLD using the neighbor information response frame. The basic ML elements for non-collocated AP MLD1 and AP MLD2 include the BSS load and AP transmit power. Non-collocated AP MLD3 is not reported on in the illustrated example because it is not reachable by the current AP MLD.

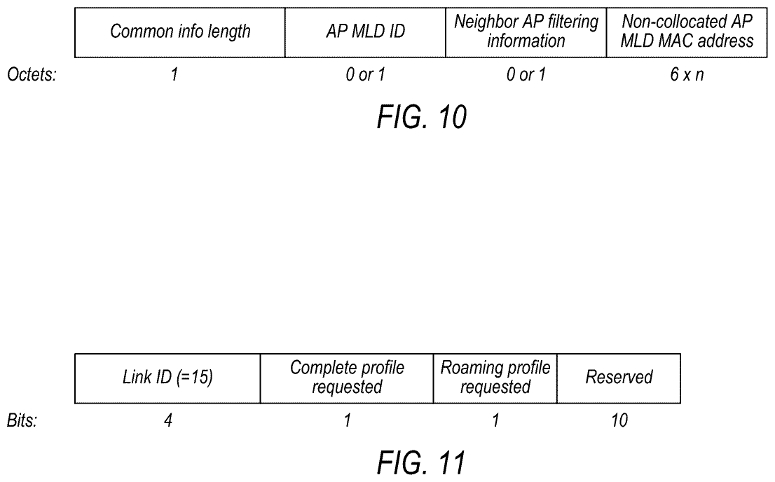

FIGS. 10-11 illustrate aspects of a possible neighbor AP information query frame that could be used for non-collocated AP MLD discovery, according to some embodiments. The neighbor AP information query may have one probe ML element, according to some embodiments. In the common info field, as shown in FIG. 10, the AP MLD ID field can be set to the associated AP MLD's MLD ID. The neighbor AP filtering information field can be set to indicate any requested filtering condition(s) for the reported non-collocated AP MLD(s). For example, in some embodiments, if the filtering condition is set, when APs affiliated with the non-collocated AP MLD are reachable by the current AP MLD, those non-collocated AP MLDs are reported, and non-reachable AP MLDs are not reported. Additional or alternative neighbor AP filtering conditions can also be defined and correspondingly indicated using this field. The non-collocated AP MLD address field can be set to the non-collocated AP MLD MAC address of interest. If this field is not present, it may be the case that all non-collocated AP MLD information is requested, or possibly all such information subject to any requested filtering condition(s). In the link info field, as shown in FIG. 11, the roaming profile requested subfield can be set to 1. In this case, the BSS load and AP transmit power of each AP affiliated with a non-collocated AP MLD reported on are requested to be included in the neighbor AP information response frame. The link ID field can be set to 15 (e.g., a reserved value) to request information for all APs of the non-collocated AP MLD(s). The roaming profile requested field can also be present in the Common Info field. In such a case, the link info field may not be present.

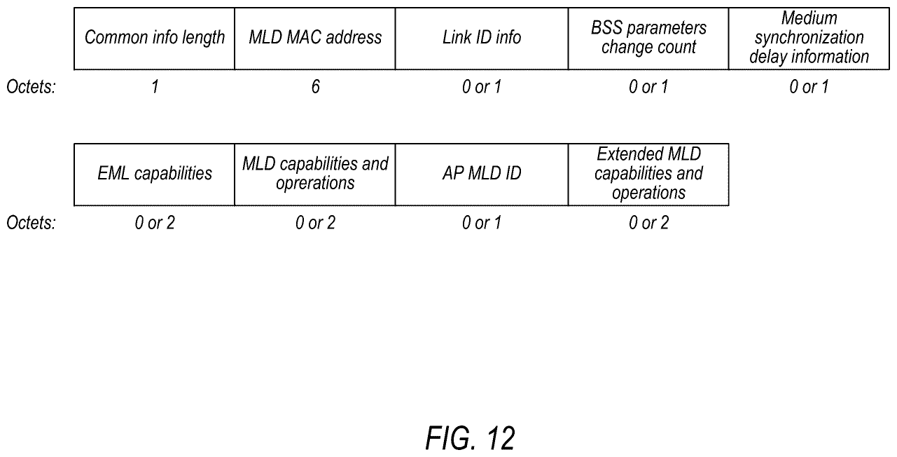

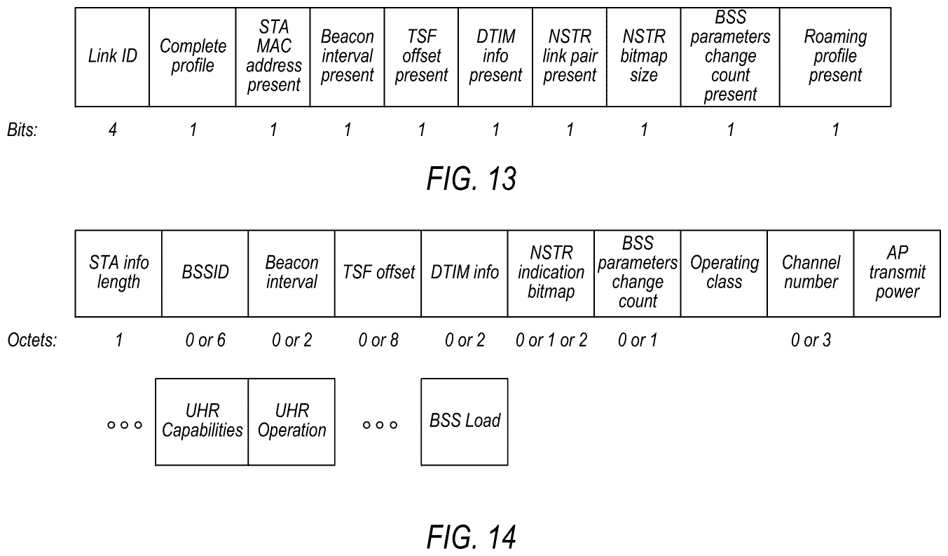

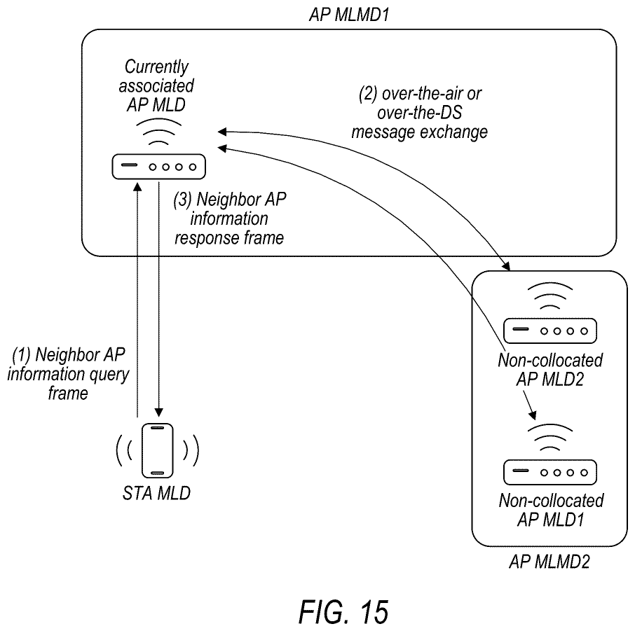

FIGS. 12-14 illustrate aspects of a possible neighbor AP information response frame that could be used for non-collocated AP MLD discovery, according to some embodiments. The neighbor AP information response may have one or more basic ML elements, for example including one for each non-collocated AP MLD for which reporting information is being provided. In the common info field for each basic ML element, as shown in FIG. 12, the MLD MAC address can be set to the corresponding non-collocated AP MLD MAC address. In the STA control field, as shown in FIG. 13, a roaming profile present indicator bit can be included. In the link info field, as shown in FIG. 14, the operating class, channel number, beacon interval, BSSID, TSF offset, AP transmit power, and BSS load element (carried in the per-STA profile sub-element) can be indicated.

A query-response framework can also potentially be used to support non-collocated AP MLD discovery in different AP MLMDs. FIG. 15 illustrates example aspects of a system in which such discovery can be performed. As shown, in the illustrated example, a STA MLD can receive information pertinent to non-collocated AP MLD(s) affiliated with a different AP MLMD through the currently associated AP MLD. The STA MLD can send a neighbor AP information query frame to the currently associated AP MLD, the current AP MLD can perform over the air or over the DS message exchange with the non-collocated AP MLD(s) to obtain the AP MLD information, and send the information about the non-collocated AP MLD(s) to the STA MLD using a neighbor AP information response frame. These frames can be protected management frames, at least in some embodiments. The neighbor AP information response frame can contain one or more basic ML element for each non-collocated AP MLD, which can for example indicate any or all of service set identifier (SSID), robust security network (RSN), operating class and channel number, capabilities and operating parameters, BSSID, beacon interval, TSF offset, BSS parameter change count, BSS load, AP transmit power, etc. In some embodiments, the STA MLD may be able to specify certain request parameters in the neighbor AP information query frame, such as a list of non-collocated AP MLD MAC addresses of interest (e.g., if known), neighbor AP filtering information (e.g., indicating if only reachable AP reporting is requested, and/or if any other filtering parameters are requested), SSID and/or RSN of interest, and/or any of various other possible request parameters.

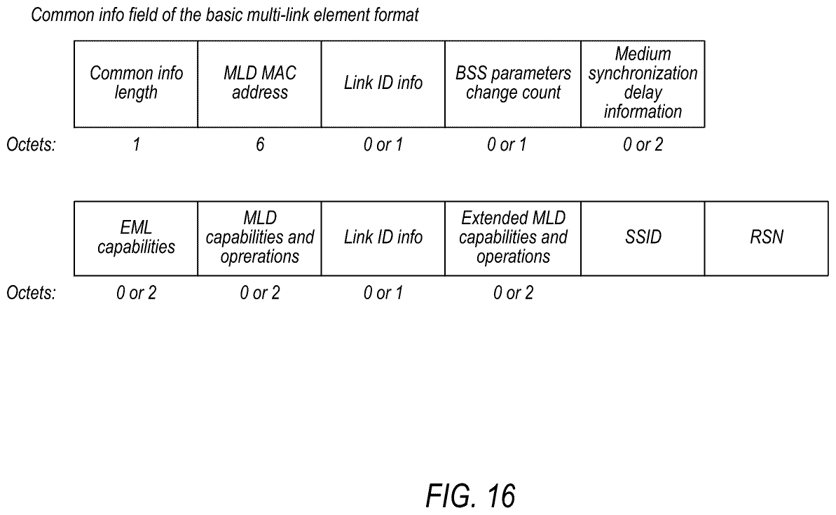

In some embodiments, similar frame formats can be used for neighbor AP information query and response frames for performing non-collocated AP MLD discovery for AP MLDs in different AP MLMDs as for performing non-collocated AP MLD discovery for AP MLDs in the same AP MLMD, such as the frame formats illustrated in FIGS. 10-14. For example, the neighbor AP information response may have one or more basic ML elements, including one for each non-collocated AP MLD for which reporting information is being provided. Alternatively, in some embodiments, one or more such frame formats can potentially be modified or otherwise have different structure in comparison to those of FIGS. 10-14. FIG. 16 illustrates example aspects of one such possible format modification to a neighbor AP information response frame that can be used for providing AP MLD information for a non-collocated AP MLD in a different AP MLMD, according to some embodiments. In the common info field for each basic ML element, as shown in FIG. 16, in addition to the MLD MAC address field potentially being set to the non-collocated AP MLD address, subfields for SSID and RSN can be included.

Thus, a neighbor AP information query/response frame format, which can be a new frame format, can be used for performing non-collocated AP MLD discovery for AP MLDs within or outside of an AP MLMD, according to various embodiments described herein. The neighbor AP information response frame can be transmitted by an AP in response to the neighbor AP information query frame. Since this can potentially be a new design for communication systems that include ultra high reliability (UHR) capabilities, a flexible design can be possible, at least according to some embodiments. However, it should be noted that other frame formats can potentially alternatively or additionally be used for performing non-collocated AP MLD discovery for AP MLDs within or outside of an AP MLMD. As one such example, a BSS transition management query/request frame (e.g., based at least in part on IEEE 802.11v) could potentially be used for such a purpose. The BSS transition management request frame can be transmitted by an AP in response to a BSS transmission management query frame, or autonomously. The BSS transition management query and request procedure may be designed for the network assisted roaming procedure, but can potentially be used (e.g., with modifications) for performing non-collocated AP MLD discovery for AP MLDs within or outside of an AP MLMD, at least according to some embodiments.

Query operations for non-collocated AP MLD discovery can be performed for any of a variety of possible reasons/use cases. As one example, such discovery can be used for scanning results verification, e.g., in which a STA has detected APs during scanning and verifies the information of the detected APs and obtains these APs parameters. In such a case, the STA can query specifically for information for the AP(s) that is (are) detected while scanning. The serving AP can thus potentially very the detected AP and information, which can benefit the STA by providing a way to easily verify that a detected AP is real and to obtain a complete set of AP parameter and performance information.

As another example, such discovery can be used for AP discovery and auto join, e.g., in which a serving AP can provide other BSSs parameters through query response signaling. The BSSs of other networks can potentially be provided. In such a case, the STA may request collocated or neighbor AP parameters. SSID or address may potentially be used to identify the queried AP(s). This can potentially help a STA discover networks relatively quickly and with relatively low power consumption. It can also be noted that the network operator may potentially promote selected networks discoverability.

Still another example can include a roaming candidate AP load and parameters check, e.g., in which a STA maintains a roaming candidate list by checking whether the APs in the list have resources available for a roaming STA. In such a case, the STA can query for the roaming candidate APs based on their OTA link address or MLD address. This can help the STA to easily update BSS parameters for the candidate APs, such that the STA can potentially just maintain the RSSI separately.

A further example can include AP discovery for roaming, e.g., in which a STA prepares for roaming, including checking its performance in potential APs through the serving AP. A STA performing such an operation can potentially ensure its performance in the neighbor AP MLDs, reduce the need for perform OTA scanning of roaming candidate APs, and potentially discover roaming candidate APs relatively quickly and with low power consumption.

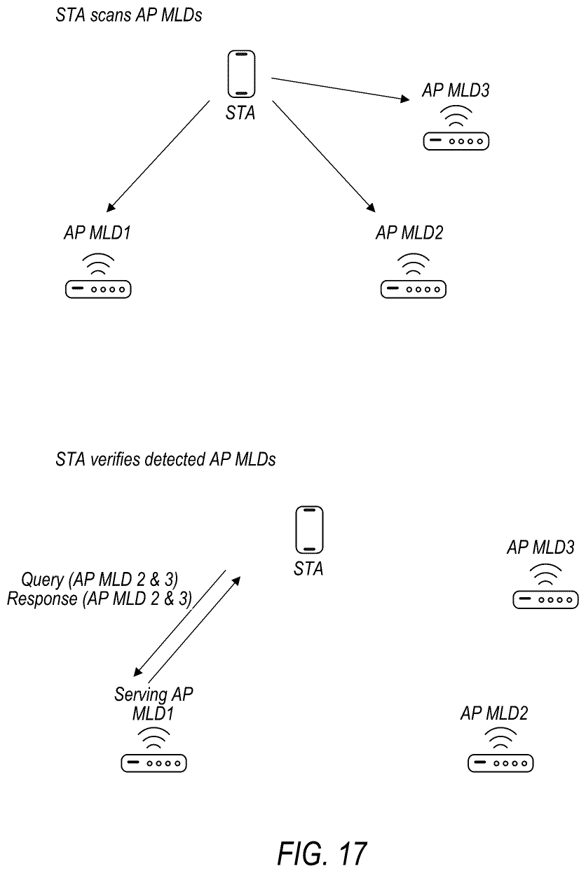

FIG. 17 illustrates example aspects of a possible scanning results verification use case for performing query/response-based AP MLD discovery, according to some embodiments. As shown, in the illustrated scenario, a STA scans available APs for auto join, and discovers OTA AP MLDs 1-3. The STA associates with AP MLD 1, then verifies AP MLDs 2 and 3 parameters through the serving AP MLD 1 using a query and response exchange.

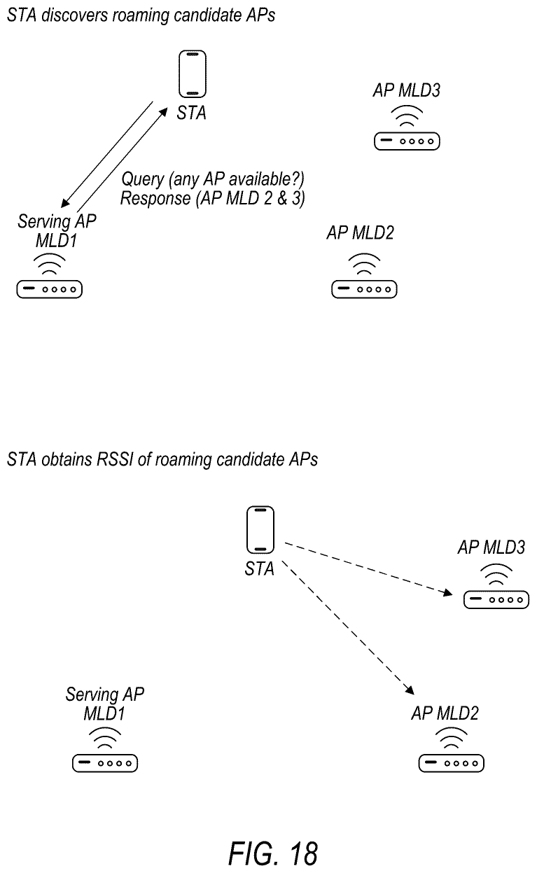

FIG. 18 illustrates example aspects of a roaming discovery enhancement use case for performing query/response-based AP MLD discovery, according to some embodiments. As shown, in the illustrated scenario, a STA is associated with serving AP MLD 1, and determines that it needs to roam. The STA requests suitable available roaming candidate APs through the serving AP using a query and response exchange. The STA does not need to know the availability of the roaming candidate APs in this case, and the network can provide available roaming candidate APs operating parameters. After querying for the most up-to-date AP parameters of the roaming candidate APs, the STA can check RSSI of the roaming candidate APs OTA to verify whether they are suitable for roaming.

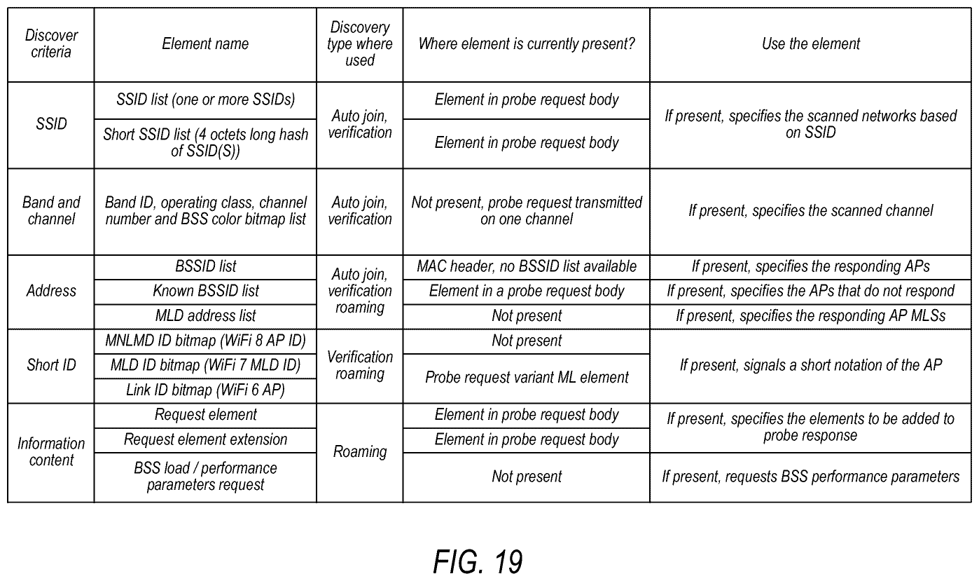

FIG. 19 is a table illustrating an example set of parameters that could be used to solicit AP information in a query/response-based approach to non-collocated AP MLD discovery, according to some embodiments. As shown, the illustrated set of discovery criteria can include SSID, band and channel, address, short ID, and/or information content. There may be one or more elements relating to each of these criteria that can be used to solicit corresponding information, and various of these elements may be present in various query/response frame locations, while for some of these elements modification or updates to query and/or response frame formats could be necessary to provide the possibility of their use (e.g., such elements may not currently be present). As also shown, these various parameters can potentially be associated with different types of discovery (e.g., in which they may be more commonly or beneficially used), and their use can specify the type of response to be provided when indicated, at least according to some embodiments. It should be noted that systems that include any number of variations on or alternatives to the features illustrated in the table of FIG. 19 are also possible, and that this particular set of parameters is provided merely by way of example.

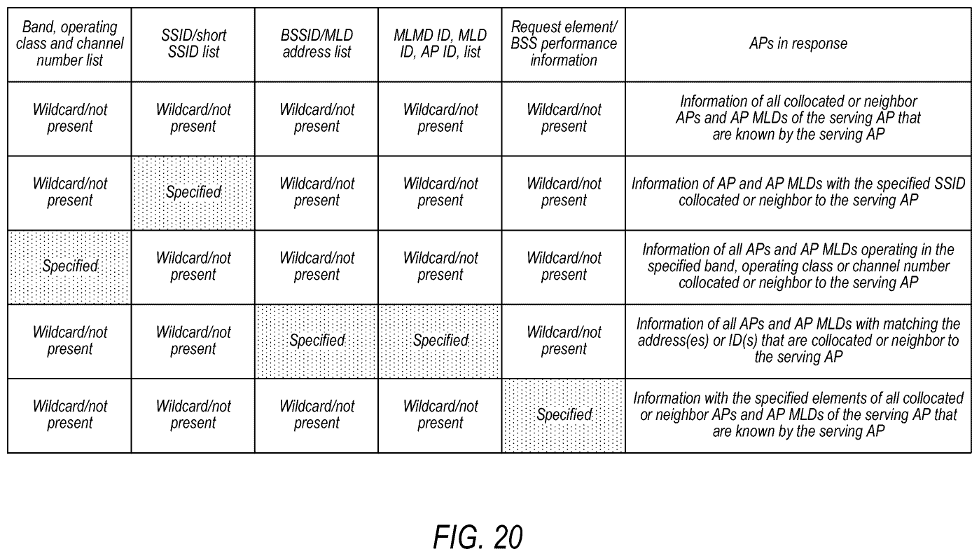

FIG. 20 is a table further illustrating how such query parameters could be used, according to some embodiments. As shown, if none of the illustrated query parameters are present, an AP may provide information for all collocated or neighbor APs and AP MLDs of the serving AP that are known by the serving AP in response to a query by a STA. If a SSID/Short SSID list parameter is specified, an AP may provide information for AP and AP MLDs with the specified SSID that are collocated with or neighbor to the serving AP. If a band, operating class and channel number list parameter is specified, an AP may provide information for all APs and AP MLDs operating in the specified band, operating class, or channel number that are collocated with or neighbor to the serving AP. If a BSSID/MLD address list parameter and/or a MLMD ID, MLD ID, AP ID list parameter is specified, an AP may provide information for all APs and AP MLDs matching with the address(es) or ID(s) that are collocated with or neighbor to the serving AP. If a request element/BSS performance information parameter is specified, an AP may provide information with the specified elements for all collocated or neighbor APs and AP MLDs of the serving AP that are known to the serving AP. If multiple query parameters are present, the AP can provide information matching with all of the indicated query parameters.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a first wireless device:
transmitting, to an access point (AP) wireless device, a query frame comprising a request for neighbor AP information for one or more non-collocated neighbor AP multi-link devices (MLDs); and
receiving, from the AP wireless device, a response frame comprising the neighbor AP information for one or more non-collocated neighbor AP MLDs.

2. The method of claim 1, wherein the response frame includes a multi-link element for each of one or more neighbor AP MLDs, wherein each multi-link element indicates, for a corresponding neighbor AP MLD, at least one of:
operating class;
channel number;
capability and operating parameter information;
basic service set (BSS) identifier (ID);
beacon interval;
timing synchronization function (TSF) offset;
BSS parameter change count;
BSS load;
AP transmit power;
service set identifier (SSID); or
robust security network (RSN).

3. The method of claim 1,
wherein the query frame indicates one or more non-collocated AP MLD media access control (MAC) addresses, and
wherein the response frame includes neighbor AP information for one or more non-collocated AP MLDs associated with the one or more non-collocated AP MLD MAC addresses.

4. The method of claim 1,
wherein the query frame indicates one or more filtering criteria for the requested neighbor AP information for non-collocated neighbor AP MLDs, and
wherein the response frame includes only neighbor AP information for one or more non-collocated neighbor AP MLDs that satisfies the indicated one or more filtering criteria.

5. The method of claim 4,
wherein the one or more filtering criteria include a requirement that each reported non-collocated neighbor AP MLD is within wireless communication range of the AP wireless device.

6. The method of claim 1,
wherein the response frame provides the requested neighbor AP information for one or more non-collocated neighbor AP MLDs in a same AP multi-link multi-device (MLMD) as the AP wireless device.

7. The method of claim 1,
wherein the response frame provides the requested neighbor AP information for one or more non-collocated neighbor AP MLDs in a different AP multi-link multi-device (MLMD) than the AP wireless device.

8. The method of claim 7,
wherein the query frame indicates at least one service set identifier (SSID) or robust security network (RSN), and
wherein the response includes neighbor AP information for at least one non-collocated AP MLD associated with the at least one SSID or RSN.

9. The method of claim 1,
wherein the query frame comprises one of a neighbor AP information query frame or a basic service set transition management (BTM) query frame, and
wherein the response comprises one of a neighbor AP information response frame or a BTM request frame.

10. A processor comprising memory configured to cause the processor to perform operations comprising:
generating a query frame configured to request neighbor AP information for one or more non-collocated neighbor AP multi-link devices (MLDs); and
receiving a response frame that comprises the requested neighbor AP information for one or more non-collocated neighbor AP MLDs.

11. The processor of claim 10,
wherein the query frame includes one or more fields for indicating zero or more query parameters configured to indicate one or more types of neighbor AP information requested for one or more non-collocated neighbor AP MLDs.

12. The processor of claim 11,
wherein, when the one or more fields for indicating zero or more query parameters indicate zero query parameters, all available types of neighbor AP information for all known non-collocated neighbor AP MLDs is requested.

13. The processor of claim 11,
wherein the one or more fields for indicating zero or more query parameters indicate one or more query parameters that comprise at least one of:
a service set identifier (SSID) parameter;
a band parameter;
a channel parameter;
an address parameter;
a multi-link multi-device (MLMD) ID, multi-link device (MLD) ID, or link ID parameter; or
an information content parameter.

14. An access point (AP) wireless device, comprising:
one or more antennas;
one or more radios operably coupled to the one or more antennas; and
a processor operably coupled to the one or more radios;
wherein the AP wireless device is configured to:
receive, from a non-AP wireless device, a query frame comprising a request for neighbor AP information for one or more non-collocated neighbor AP multi-link devices (MLDs); and
transmit, to the non-AP wireless device, a response frame comprising the requested neighbor AP information for one or more non-collocated neighbor AP MLDs.

15. The AP wireless device of claim 14, wherein the AP wireless device is further configured to:
perform an over-the-air (OTA) or over-the-distribution system (OTDS) message exchange with one or more non-collocated neighbor AP MLDs to obtain the neighbor AP information.

16. The AP wireless device of claim 14, wherein the response frame includes a multi-link element for a neighbor AP MLD of the one or more neighbor AP MLDs, wherein the multi-link element indicates at least one of:
operating class;
channel number;
capability and operating parameter information;
basic service set (BSS) identifier (ID);
beacon interval;
timing synchronization function (TSF) offset;
BSS parameter change count;
BSS load;
AP transmit power;
service set identifier (SSID); or
robust security network (RSN).

17. The AP wireless device of claim 14, wherein the query frame indicates one or more query parameters for the requested neighbor AP information for one or more non-collocated neighbor AP MLDs, wherein the AP wireless device is further configured to:
select neighbor AP information for one or more non-collocated neighbor AP MLDs to include in the response frame based at least in part on the indicated one or more query parameters.

18. The AP wireless device of claim 17, wherein the indicated one or more query parameters comprise at least one of:
a service set identifier (SSID) list;
a short SSID list;
a band identifier;
an operating class;
a channel number;
a basic service set (BSS) color bitmap list;
a BSS identifier (BSSID) list;
a known BSSID list;
a multi-link device (MLD) address list;
a multi-link multi-device (MLMD) identifier bitmap;
a MLD identifier bitmap;
a link identifier bitmap;
an information content request element;
a BSS load request; or
a BSS performance parameters request.

19. The AP wireless device of claim 14, wherein the AP wireless device is associated with a first AP multi-link multi-device (MLMD), and
wherein the response frame provides neighbor AP information for one or more non-collocated neighbor AP MLDs in the first AP MLMD.

20. The AP wireless device of claim 14, wherein the AP wireless device is associated with a first AP multi-link multi-device (MLMD), and
wherein the response frame provides neighbor AP information for one or more non-collocated neighbor AP MLDs in a second AP MLMD.
